(19) United States
(12) Patent Application Publication
(10) Pub. No.: US 2018/0328091 A1
(43) Pub. Date: Nov. 15, 2018

(54) INSTALLATION ADJUSTING STRUCTURE OF GLASS LIFTER FOR USE IN VEHICLE

(71) Applicants: Francisco Javier Martinez Moral, MADRID (ES); HSIN CHONG MACHINERY WORKS CO. LTD., New Taipei City (TW); FUZHOU MINGFANG AUTOMOBILE PARTS INDUSTRY CO., LTD., FUZHOU (CN)

(72) Inventors: Chi-Ming HUANG, New Taipei City (TW); Kuang-Yu CHIANG, New Taipei City (TW)

(21) Appl. No.: 15/594,769

(22) Filed: May 15, 2017

(51) Int. Cl. E05D 15/16; B60J 1/16; E05F 7/00

(52) U.S. Cl. CPC E05D 15/165; E05Y 2900/55; E05F 7/005; B60J 1/16

(57) ABSTRACT

An installation adjusting structure of glass lifter for use in vehicle, which is installed in a vehicle body and includes: at least one guide rail having a plurality of screw fitting parts; and a plurality of adjustment members disposed on the screw fitting parts, wherein the adjustment member includes an adjustment bolt and a stop member disposed on the adjustment bolt, the adjustment bolt is allowed to pass the vehicle body and fitted with the screw fitting part, the stop member is abutted against the vehicle body, and the depth of the adjustment bolt being screwed and fitted in the screw fitting part is adjustable. Accordingly, an advantage of allowing an inclined glass to be precisely and rapidly adjusted and calibrated can be achieved.

### BACKGROUND OF THE INVENTION

### Field of the Invention

The present invention relates to a glass lifter, especially to an installation adjusting structure of glass lifter for use in vehicle.

### Description of Related Art

A vehicle-used glass is mostly installed in a vehicle body, for example a vehicle door; and for allowing the glass to be lifted, a glass lifter is required to be disposed in the vehicle body.

For the glass and the vehicle body, the angle defined between the above two has to be aligned, otherwise the inclined angle defined in the longitudinal direction of the glass would be different from that of the vehicle body, for example: the top edge of the glass is overly inclined toward the interior of the vehicle, or the bottom edge of the glass is overly inclined towards the exterior of the vehicle, the above-mentioned situations would cause the glass to be inclined, unable to be engaged, or even jammed and unable to be lifted; and for a specially-designed vehicle having frameless window, there is no window frame for the purpose of guidance while the glass is lifted from the vehicle body.

However, a conventional glass lifter can only control the glass to be lifted, if the glass is desired to be calibrated, a professional personnel with profound experiences is needed for such calibration and adjustment, so that unnecessary labor and time are wasted.

Accordingly, the applicant of the present invention has devoted himself for improving the mentioned disadvantages.

### SUMMARY OF THE INVENTION

The present invention is to provide an installation adjusting structure of glass lifter for use in vehicle, which has an advantage of allowing an inclined glass to be precisely and rapidly adjusted and calibrated.

Accordingly, the present invention provides an installation adjusting structure of glass lifter for use in vehicle, which is installed in a vehicle body and includes: at least one guide rail having a plurality of screw fitting parts; and a plurality of adjustment members disposed on the screw fitting parts, wherein the adjustment member includes an adjustment bolt and a stop member disposed on the adjustment bolt, the adjustment bolt is allowed to pass the vehicle body and fitted with the screw fitting part, the stop member is abutted against the vehicle body, and the depth of the adjustment bolt being screwed and fitted in the screw fitting part is adjustable.

In comparison with prior art, the present invention has advantageous features as follows: the inclined glass can be precisely and rapidly adjusted and calibrated, and effects of easy adjustment and saving time and effort are provided.

### BRIEF DESCRIPTION OF DRAWING

FIG. 1 is a perspective view showing a glass lifter of an installation adjusting structure according to the present invention;

FIG. 2 is a perspective view showing the installation adjusting structure wherein a guide rail at the right side of FIG. 1 being shown according to the present invention;

FIG. 3 is another perspective view showing the installation adjusting structure wherein the guide rail at the right side of FIG. 1 being shown according to the present invention;

FIG. 4 is a partially perspective exploded view showing the installation adjusting structure wherein an upper distal end of the guide rail being shown according the present invention;

FIG. 5 is a side view showing the assembly of FIG. 4 according to the present invention;

FIG. 6 is a side view showing an operating status after the installation adjusting structure of FIG. 5 being installed in a vehicle body according to the present invention;

FIG. 7 is a partially perspective exploded view showing the installation adjusting structure wherein a lower distal end of the guide rail being shown according the present invention;

FIG. 8 is a side view showing the assembly of FIG. 7 according to the present invention; and

FIG. 9 is a side view showing an operating status after the installation adjusting structure of FIG. 8 being installed in a vehicle body according to the present invention.

### DETAILED DESCRIPTION OF THE INVENTION

A preferred embodiment of the present invention will be described with reference to the drawings.

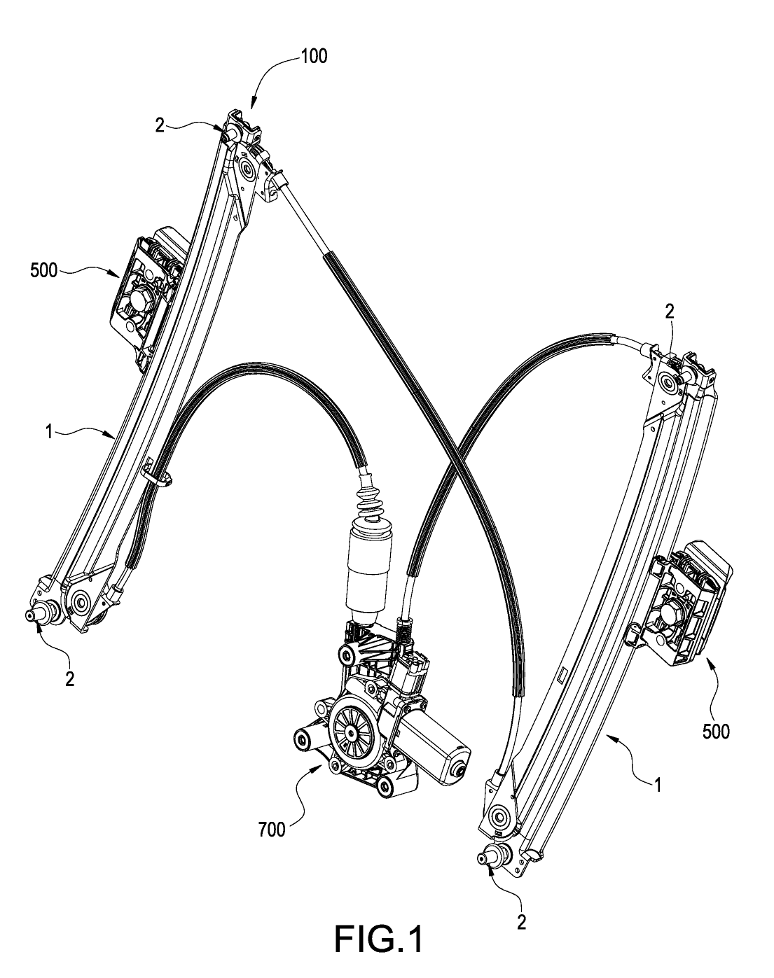

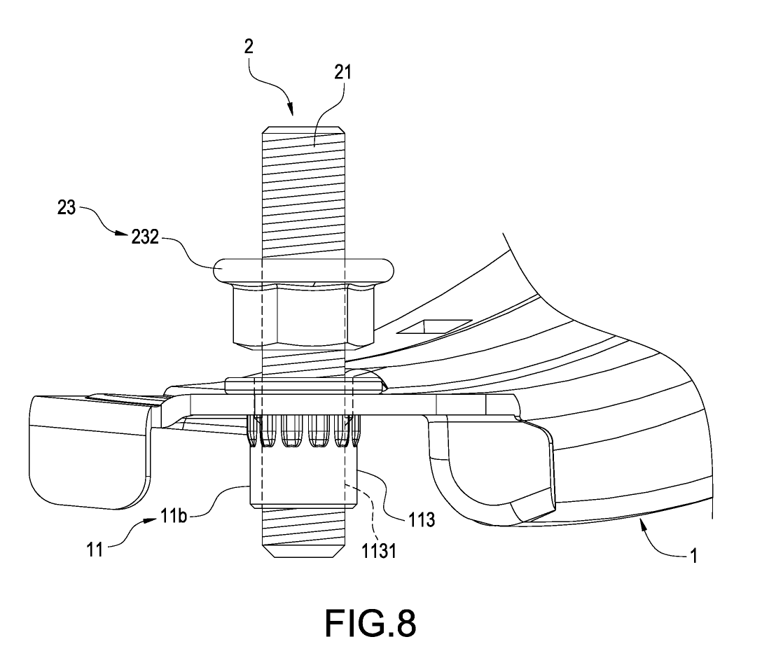

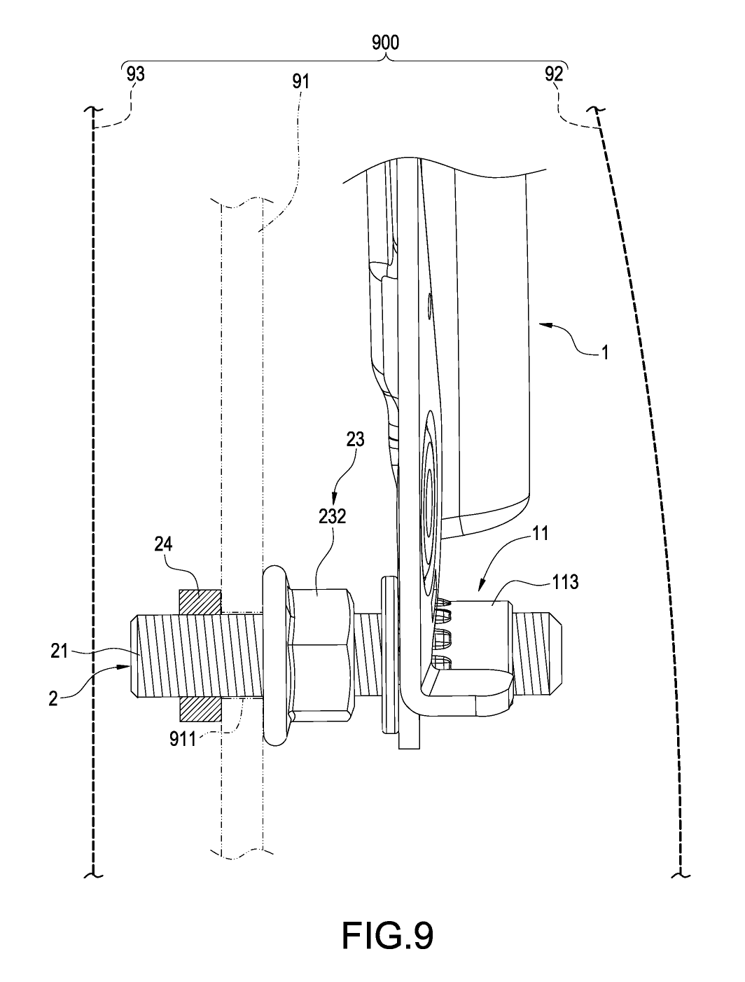

The present invention provides an installation adjusting structure of glass lifter for use in vehicle. Please refer to FIG. 1, the glass lifter is installed at any suitable location of a vehicle body 900 (as shown in FIG. 8 and FIG. 9), and includes: an installation adjusting structure 100, a glass clamping device 500 and a drive controlling device 700. Glasses (not show in figures) are clamped and fastened by a plurality of the glass clamping devices 500, and the drive controlling device 700 is served to control the glass clamping device 500 to be lifted in the installation adjusting structure 100 via a connection cable (not coded).

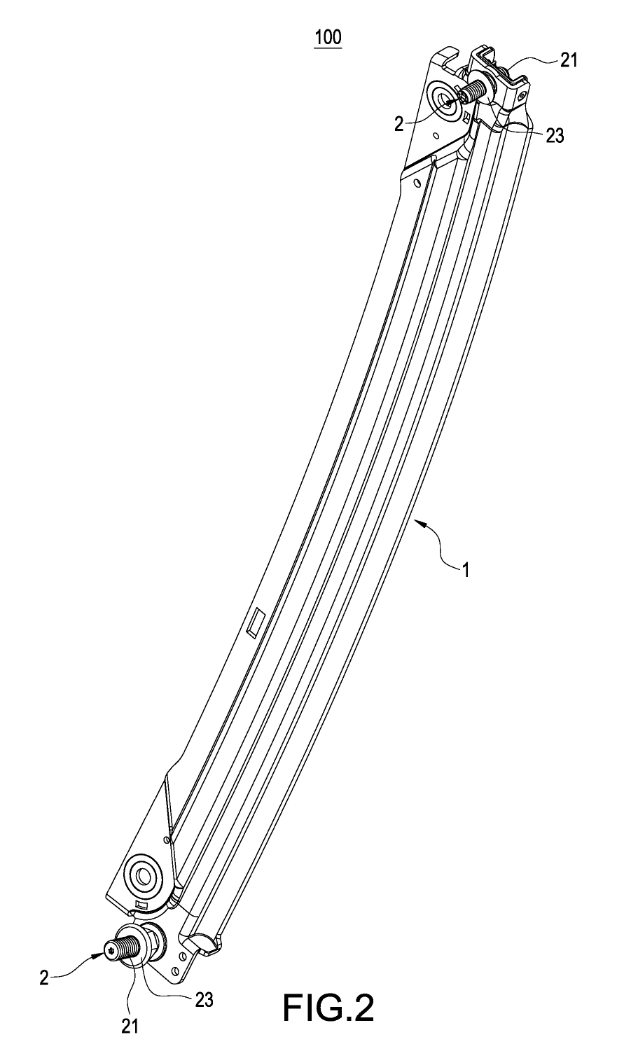

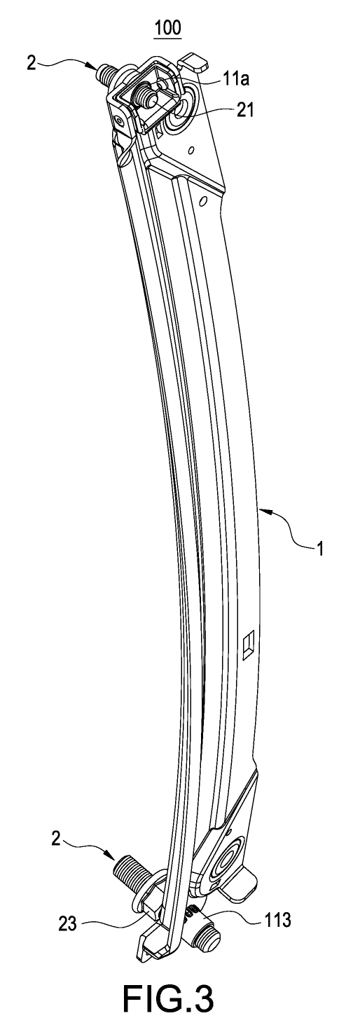

Please refer from FIG. 1 to FIG. 3, the installation adjusting structure 100 provided by the present invention includes at least one guide rail 1 and a plurality of adjustment members 2. The guide rail 1 can be formed as one piece or plural pieces, according to this embodiment, two pieces are adopted for providing a detailed illustration. Accordingly, there are two guide rails 1 arranged at the left and the right side as shown in FIG. 1, and the above-mentioned glass clamping device 500 is connected to the guide rail 1 with a sliding means.

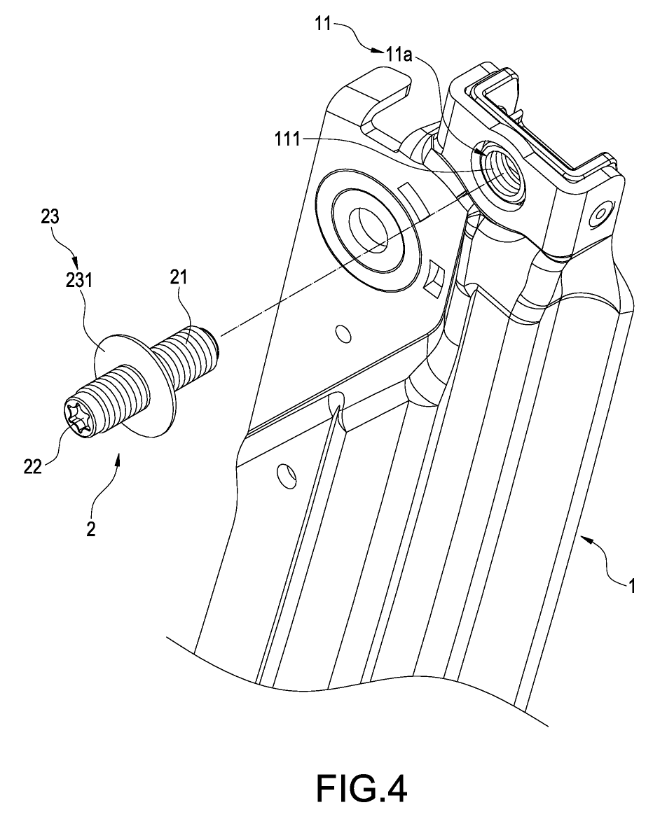

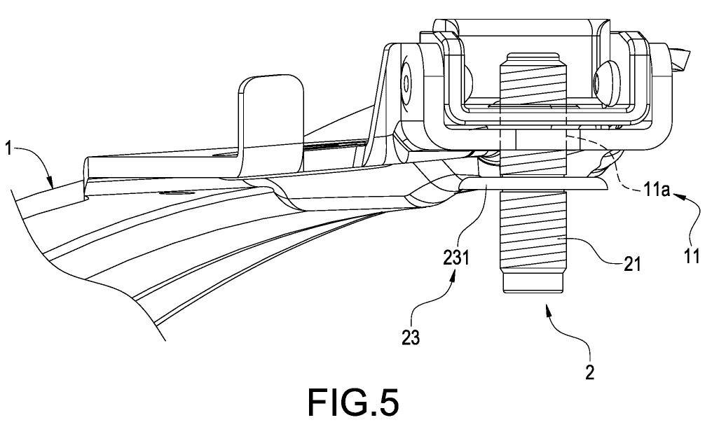

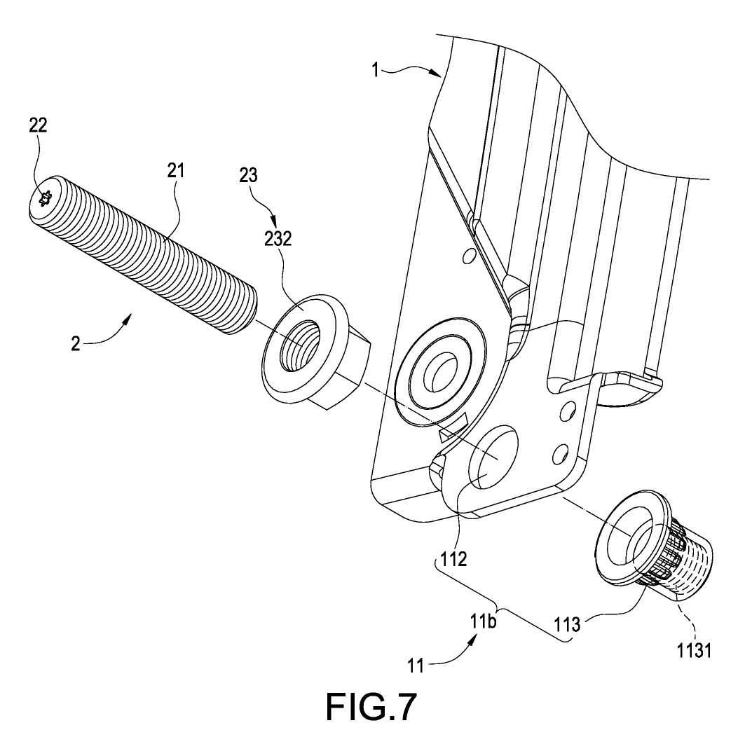

Please refer to FIG. 4 and FIG. 5, and FIG. 7 and FIG. 8, the guide rail 1 is formed with a plurality of screw fitting parts 11, according to this embodiment, a top screw fitting part 11a (as shown in FIG. 4) and a bottom screw fitting part 11b (as shown FIG. 7) arranged to be away from each other are adopted for providing a detailed illustration, so that a top edge and a bottom edge of the glass can be respectively adjusted with respect to the inclined status of the vehicle body.

The top screw fitting part 11a and the bottom screw fitting part 11b can be formed as the same structure, but also can be formed as different structures; according to this embodiment, the different structures are adopted for providing a detailed illustration. Wherein, the top screw fitting part 11a (as shown in FIG. 4 and FIG. 5) is a screw hole 111 formed at an upper distal end of the guide rail 1; the bottom screw fitting part 11b (as shown in FIG. 7 and FIG. 8) includes an opening 112 formed on the guide rail 1 and an insert nut 113 correspondingly fastened with the opening 112, and the insert nut 113 is formed with a screw hole 1131.

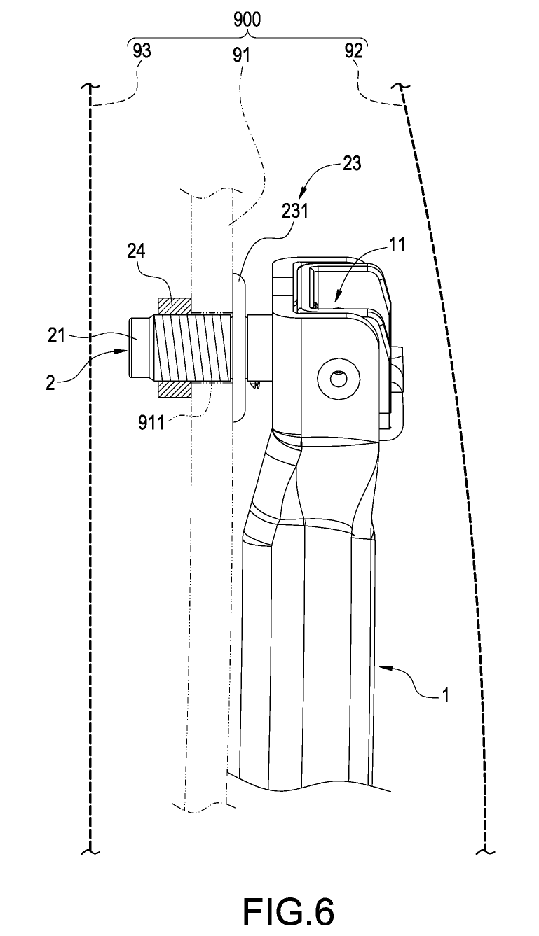

The adjustment member 2 is disposed on the screw fitting part 11 and includes: an adjustment bolt 21 and a stop member 23 disposed on the adjustment bolt 21, and preferably includes: an adjustment part 22 formed on the adjustment bolt 21 and an installation nut 24 fitted on the adjustment bolt 21 after an adjustment operation being processed (as shown in FIG. 6 and FIG. 9).

The adjustment bolt 21 is fitted on the screw fitting part 11, according to this embodiment, there are four adjustment bolts 21 are fitted on the top screw fitting part 11a (i.e. the screw hole 111) and the bottom screw fitting part 11b (i.e. the screw hole 1131) of the guide rail 1 at the left side and fitted on the top screw fitting part 11a and the bottom screw fitting part 11b of the guide rail 1 at the right side.

The adjustment part 22 can be formed as any structure allowing the adjustment bolt 21 to be rotated, according to this embodiment, a screw having the inner periphery formed in a polygonal status hole is adopted for providing a detailed illustration (a hexagonal screw hole as shown in FIG. 4 and FIG. 7), so that a tool having the outer periphery formed in a corresponding polygonal status can be utilized for enabling the adjustment bolt 21 to be rotated.

The stop members 23 disposed on the top screw fitting part 11a and the bottom screw fitting part 11b can be formed as the same structure, but also can be formed as different structures, according to this embodiment, the different structures are adopted for providing a detailed illustration. Wherein, the stop member 23 (as shown in FIG. 4 and FIG. 5) disposed on the top screw fitting part 11a is formed as a stop plate 231; the stop member 23 (as shown in FIG. 7 and FIG. 8) disposed on the bottom screw fitting part 11b is formed as a stop nut 232.

Please refer to FIG. 6 and FIG. 9, according to this embodiment, the arrangement of the glass lifter being installed in a vehicle door of the vehicle body 900 is adopted for providing a detailed illustration. Wherein, the vehicle door includes an inner door panel 91 at the inner side of the vehicle and an outer door panel 92 at the outer side of the vehicle, and preferably includes a decoration panel 93 served to shield the inner door panel 91. The glass lifter is installed on the inner door panel 91 and disposed between the inner door panel 91 and the outer door panel 92.

According to the installation adjusting structure 100 provided by the present invention, the adjustment bolt 21 is allowed to pass a penetrated hole 911 of the inner door panel 91; then, there are four installation nuts 24 are fitted with the four adjustment bolts 21, so that the stop member 23 and the installation nut 24 are disposed on two opposite surfaces of the inner door panel 91, and the stop member 23 is abutted against the inner door panel 91; when an adjustment operation is desired to be processed, the above-mentioned tool is utilized for controlling the adjustment bolt 21 to be rotated clockwise or counterclockwise via the adjustment part 22, in other words for controlling the depth of the adjustment bolt 21 being screwed in or out of the screw fitting part 11, so that the distal end (the upper distal end or the lower distal end) of the guide rail 1 can be controlled to be close or away from the inner door panel 91, thereby achieving an objective of adjustment; when the adjustment operation is finished, the installation nut 24 is tightened towards the inner door panel 91, so that the stop member 23 and the installation nut 24 are tightened and relatively clamped between the two opposite surfaces of the inner door panel 91, thereby finishing the installation adjustment operation.

As shown in FIG. 1, after the glass lifter is processed with the installation adjustment operation, the inclined angle defined in the longitudinal direction of the guide rail 1 is adjusted to be aligned with that of the vehicle door, so that the inclined angle defined in the longitudinal direction of the glass is also adjusted to be aligned with that of the vehicle door. As such, when the drive controlling device 700 is served to control the glass clamping device 500 to be lifted on the guide rail 1, the glass (not shown in figures) clamped and fastened by the glass clamping device 500 is able to be fully engaged with the vehicle body 900, and a smooth lifting process can be achieved during the lifting operation.

Based on what has been disclosed above, advantages achieved by the present invention are as follows: the installation adjusting structure 100 allows the inclined glass to be precisely and rapidly adjusted and calibrated, so that effects of easy adjustment and saving time and effort are provided.

Moreover, other advantages are achieved by the present invention, as follows: the present invention is suitable to be applied in a vehicle having frameless window, and the top edge of the glass which has been fully lifted can be completely engaged with the vehicle body, so that the precision and the high quality of the vehicle having frameless window can be presented.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An installation adjusting structure of glass lifter for use in vehicle, installed in a vehicle body and including:
at least one guide rail having a plurality of screw fitting parts; and
a plurality of adjustment members disposed on the screw fitting parts, wherein the adjustment member includes an adjustment bolt and a stop member disposed on the adjustment bolt, the adjustment bolt is allowed to pass the vehicle body and fitted with the screw fitting part, the stop member is abutted against the vehicle body, and the depth of the adjustment bolt being screwed and fitted in the screw fitting part is adjustable.

2. The installation adjusting structure of glass lifter for use in vehicle according to claim 1, wherein the adjustment member further includes an installation nut fitted on the adjustment bolt, and the stop member and the installation nut are relatively clamped on two opposite surfaces of the vehicle body.

3. The installation adjusting structure of glass lifter for use in vehicle according to claim 2, wherein the stop member is a stop plate or a stop nut.

4. The installation adjusting structure of glass lifter for use in vehicle according to claim 1, wherein the adjustment member further includes an adjustment part formed on the adjustment bolt, and the adjustment part is a screw hole having the inner periphery formed in a polygonal status.

5. The installation adjusting structure of glass lifter for use in vehicle according to claim 1, wherein the screw fitting part is a screw hole formed on the guide rail.

6. The installation adjusting structure of glass lifter for use in vehicle according to claim 1, wherein the screw fitting part includes an opening formed on the guide rail and an insert nut correspondingly fastened with the opening, and the insert nut is formed with a screw hole corresponding to the adjustment bolt.

7. The installation adjusting structure of glass lifter for use in vehicle according to claim 1, wherein the screw fitting part of the guide rail includes a top screw fitting part and a bottom screw fitting part arranged to be away from each other.

8. The installation adjusting structure of glass lifter for use in vehicle according to claim 1, wherein there are a plurality of the guide rails, and each of the plurality of guide rails includes a plurality of the screw fitting parts.
